(19) United States
(12) Patent Application Publication
(10) Pub. No.: US 2008/0217348 A1
(43) Pub. Date: Sep. 11, 2008

(54) Vend sensing system

(75) Inventor: James Winsor, Corona, CA (US)

Correspondence Address: VENABLE LLP, P.O. BOX 34385, WASHINGTON, DC, 20043-9998, US

(73) Assignee: Automated Vending Technology, Inc., Yorba Linda, CA (US)

(21) Appl. No.: 11/976,311

(22) Filed: Oct. 23, 2007

Related U.S. Application Data
(60) Provisional application No. 60/853,424, filed on Oct. 23, 2006.

(51) Int. Cl. G07F 11/00

(52) U.S. Cl. 221/13

(57) ABSTRACT

A vend sensing system (or “VSS”) 200 detects that a single vended product has dropped from one of the dispensing columns directly above the sensing system and has fallen into the customer delivery bin at the base of the vending system.

### BACKGROUND OF THE INVENTION

1. Field of the Invention

The present invention relates generally to automated vending machines, and more particularly to a system for sensing vending of products sold in such machines.

2. Related Art

Automated vending systems used to accept a patron's currency and then vend a variety of products have been developed and deployed in the public space for many years. Recently deployed vending systems now employ a glass face front door allowing a visual view of the product which is intended to be vended. This glass face has many distinctive features, one being that the patron using the vending system can visually identify the desired product then visually watch the vending process. Occasionally during this vending process there is a problem with the vend cycle. The product may either “hang” on the end of a dispensing auger, or the column itself may be out of the specific product thereby turning a spiral auger where the product has already been depleted. This is usually due to an inadvertent location being selected by the patron, or there may just be a jam in the rotating auger. In any of these cases, the product did not vend and the patron has an unpleasant and lasting issue with using this self service vending product.

### SUMMARY OF THE INVENTION

In an exemplary embodiment of the present invention, a vend sensing system is provided to positively detect that the vending machine dropped the product into the product delivery bay during the vending cycle.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of exemplary embodiments of the invention, as illustrated in the accompanying drawings wherein like reference numbers generally indicate identical, functionally similar, and/or structurally similar elements.

FIG. 1 depicts a vending machine according to embodiments of the present invention; and

FIG. 2 depicts a block diagram of the vend sensing system according to embodiments of the present invention.

### DETAILED DESCRIPTION OF EMBODIMENTS OF THE PRESENT INVENTION

Exemplary embodiments of the invention are discussed in detail below. While several specific exemplary embodiments may be discussed, it should be understood that this is done for illustration purposes only. A person skilled in the relevant art will recognize that other components and configurations can be used without departing from the spirit and scope of the invention.

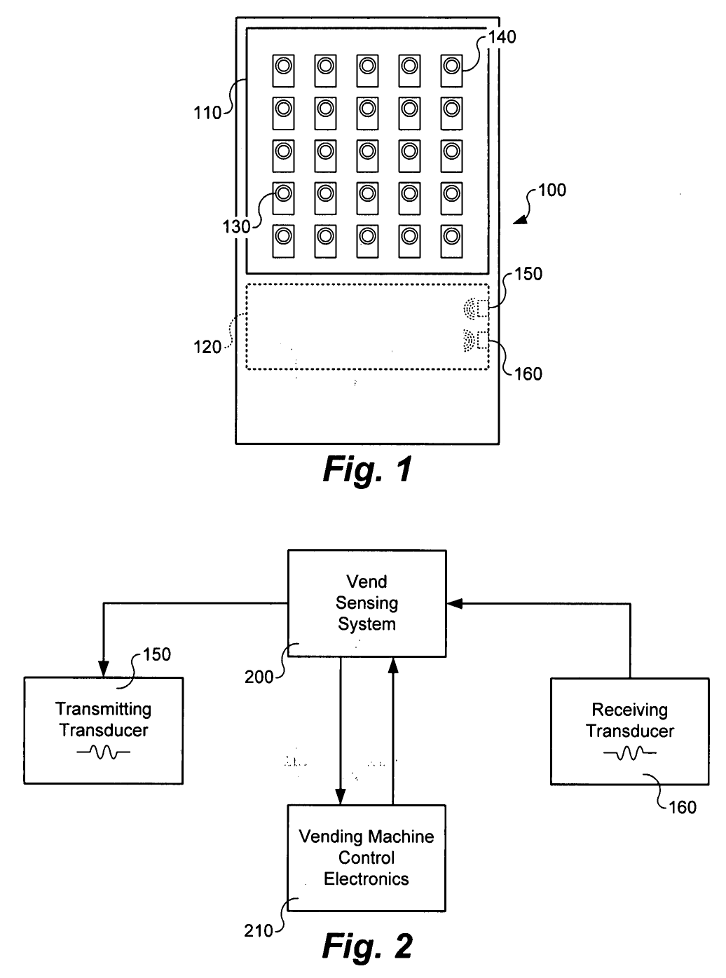

As shown in FIGS. 1 and 2, a vend sensing system (or “VSS”) 200 was developed specifically to detect that a single vended product has dropped from one of the dispensing columns directly above the sensing system and has fallen into the customer delivery bin at the base of the vending system.

The VSS 200 is coupled directly with the vending machine control electronics 210 in such a way that the circuitry of the VSS 200 is disabled until the vending machine control electronics 220 has received a signal indicating a proper form of payment. Once proper payment has been received or verified, the control electronics 210 enables the circuitry of the VSS 200 to detect product which has been dispensed then dropped into the delivery bin 120 below. During this sensing period, the circuitry of the VSS 200 is only enabled for the empirical time period it takes to detect any one of the vendible products 140 to fall into the delivery bin 120 once the control electronics 210 has applied the signal for the dispensing auger 130 to dispense a single product 140.

During the enabled period of time, the circuitry of the VSS 200 uses a calibrated ultrasonic beam (shown schematically in FIG. 1) to detect if an object of just about any size, form and shape—calibrated for just about any object that can be vended—has fallen into the detectable space of the customer product delivery bin 120. If an object (i.e., vended product 140) enters the detectable vending space 120, the circuitry of the VSS 200 detects the object and in turn sends a “detected” signal to the control electronics 210. Likewise, if the circuitry of the VSS 200 does not detect an object has entered the customer delivery bin space 120 within the allotted empirical time frame, the circuitry of the VSS 200 returns a command signal to the control electronics 210 that a “no vend object detected”. It is the responsibility of the control electronics 210 to determine the next appropriate action to take.

The VSS 200 detects objects that have fallen into the customer delivery bin 120 by sensing a disruption or distortion in a transmitted ultrasonic beam. This detection is done by a pair of ultrasonic transducers 150, 160 located at one extreme end of the customer delivery bin 120. One of the transducers transmits a calibrated ultrasonic (i.e., a high frequency not detectable by the human ear) sound beam from a transducer known as the transmitting transducer 150. The ultrasonic sound wave then travels across the cross sectional area of the customer delivery bin 120 where it reflects off the back and surrounding sidewalls within the delivery bin 120 and until it is received by the receiving transducer 160 located on the same wall as the transmitting transducer 150. This receiving transducer 160 receives the reflected ultrasonic sound beam that had been transmitted by the transmitting transducer 150, and passes the signal to the circuitry of the VSS 200 for processing.

The VSS 200 uses a wave pattern and timing algorithm such that once the ultrasonic beam has been transmitted, the circuitry of the VSS 200 tracks this beam and looks for disruption and distortion in the beam via the circuitry of the receiving transducer 160. When enabled, the circuitry of the VSS 200 is constantly emitting the primary ultrasonic beam then in turn receiving and checking this primary ultrasonic beam ensuring the received beam meets the same wave pattern and timing algorithm that is originally produced and transmitted. If deflections and distortions have been determined, the beam can now be defined as the “disrupted beam”. When the circuitry of the VSS 200 detects a disrupted beam, the circuitry sends a signal to the vending machine control electronics 210 that the VSS 200 has detected an object in the customer delivery bin 120. Likewise, if the circuitry of the VSS 200 has been enabled and returns a signal to the vending machine control electronics 210 that no object has been detected, the vending machine 100 now has the option of attempting a second vend of the same product, offering another selection or refunding the customer's payment.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A vending machine, comprising:
means for distributing one or more products into a customer delivery bin upon payment therefore by a customer;
control electronics coupled to said distributing means for controlling distribution of said one or more products; and
ultrasonic means for sensing a presence of product distributed by said distributing means within said customer delivery bin, said ultrasonic sensing means coupled to said control electronics in order to selectively enable or disable said distributing means dependent upon the presence of said one or more products in said customer delivery bin.

2. The vending machine according to claim 1, wherein said distributing means comprises a plurality of dispensing augers, each of which is adapted to hold a plurality of products.

3. The vending machine according to claim 2, wherein said control electronics further comprises means for transmitting a dispense signal to cause a selected one of said plurality of dispensing augers to dispense its product.

4. The vending machine according to claim 1, wherein said sensing means comprises a pair of ultrasonic transducers, one of which is adapted to transmit a calibrated beam and the other of which is adapted to receive reflections of said calibrated beam as reflected off said customer delivery bin.

5. The vending machine according to claim 4, wherein said calibrated beam is adapted to be disrupted by products contained within said vending machine.

6. The vending machine according to claim 5, wherein said receiving transducer is adapted to send a vend signal to said control electronics upon detection of said disrupted beam.
